(19) United States
(12) Patent Application Publication
(10) Pub. No.: US 2008/0172400 A1
(43) Pub. Date: Jul. 17, 2008

(54) Techniques to manage an entity model

(75) Inventor: David Koronthaly, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/652,449

(22) Filed: Jan. 11, 2007

(51) Int. Cl. G06F 17/30

(52) U.S. Cl. 707/100; 707/E17.048

(57) ABSTRACT

Techniques to manage an entity model are described. An apparatus comprises an entity model manager to load at least one input model representing a markup language document into a memory unit, generate an entity model document object model comprising artifacts from the input model, and generate an output model using the artifacts. Other embodiments are described and claimed.

### BACKGROUND

A line of business (LOB) system may include various LOB application programs typically implemented on enterprise hardware platforms for a business entity. LOB application programs are application programs designed to provide various business application services. Examples of LOB application programs may include a Customer Relationship Management (CRM) application program, an Enterprise Resource Planning (ERP) application program, a Supply Chain Management (SCM) application program, and other business application programs using business-oriented application logic. Various application programs such as LOB application programs may build and use customized data models stored as structured documents, such as Extensible Markup Language (XML) or Hypertext Markup Language (HTML) documents. As a LOB application program is upgraded or replaced, the customized data models may also need to be modified or replaced. This may consume significant resources in terms of time and development costs, particularly as the size of the business entity and data models increase.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to an entity model document object model (DOM) suitable for use in modifying, editing, copying, merging, slicing or otherwise converting artifacts from previously defined or existing data models to new models in a uniform and well-defined manner. Some embodiments are particularly directed to an entity model DOM to convert data models for LOB application programs. The new data models may be used for various use scenarios, including a basis for the generation of Entity Web Service (EWS) contracts and other use scenarios.

In one embodiment, for example, an entity model manager may provide a set of software components arranged to provide various operations for managing and manipulating the customized data models. Examples of model management operations may include loading a model from a structured stream into a memory unit, creating a model slice from a model, merging multiple models into a single model, saving a model to persistent storage, and so forth. In this manner, previously defined customized data models may be used to create new data models to accommodate changes or evolutions in the underlying application programs. Other embodiments are described and claimed.

### BRIEF DESCRIPTION OF THE DRAWINGS

FIG. 1 illustrates one embodiment of an entity model system.

FIG. 2A illustrates one embodiment of a first class diagram.

FIG. 2B illustrates one embodiment of a second class diagram.

FIG. 3 illustrates one embodiment of a third class diagram.

FIG. 4 illustrates one embodiment of a logic flow.

FIG. 5 illustrates one embodiment of a computing system architecture.

### DETAILED DESCRIPTION

Various embodiments are generally directed to an entity model DOM suitable for use in modifying, editing, copying, merging, slicing or otherwise converting artifacts, artifact definitions or model artifacts (collectively referred to as “artifacts”) from previously defined or existing data models to new models in a uniform and well-defined manner. In some embodiments, the entity model DOM may be similar to those defined by the World Wide Web Consortium (W3C) DOM Specifications. The W3C DOM Specifications define a platform and language-neutral interface that allows programs and scripts to dynamically access and update the content, structure and style of documents. The DOM provides a standard set of objects for representing structured documents, a standard model of how these objects can be combined, and a standard interface for accessing and manipulating them. Examples of structured documents may include Hypertext Markup Language (HTML) documents, Extensible Markup Language (XML) documents, Extensible HTML (XHTML) documents, Standard Generalized Markup Language (SGML) documents, and so forth. Vendors can support the DOM as an interface to their proprietary data structures and application program interfaces (APIs), and content authors can write to the standard DOM interfaces rather than product-specific APIs, thus increasing interoperability on the World Wide Web.

A business entity typically invests a significant amount of resources in defining customized data models for various LOB application programs. For example, a CRM application program may have models for a large number of different customers, including customer contact information, purchase histories, purchase patterns, product preferences, delivery preferences, pricing data, and so forth. Moreover, the data model may have been built over a relatively long period of time. As the CRM application program is upgraded over time, however, the customized data model also needs to be updated to ensure compatibility with the upgraded CRM application program. In some cases, the upgrades are substantial enough to necessitate a complete re-write of the customized data model. This may be an expensive, time consuming, and tedious process, requiring significant data entry and/or data migration efforts.

Various embodiments may attempt to solve these and other problems. Various embodiments may be directed to an entity model DOM suitable for creating new data models from existing data models. In one embodiment, for example, the entity model DOM may comprise a shared component providing an internal representation of a model in a memory unit. An entity model manager may provide a set of software components arranged to perform various model management operations on the internally represented model to create a new model. Examples of model management operations may include but are not limited to creating a new model by extracting one or more complete entities from a previously defined model to form a model slice, merging multiple models or model slices to form a unified model, saving a new model to persistent storage as a structured document file, and so forth. In this manner, some or all portions of previously defined customized data models may be reused to create new data models to accommodate changes or evolutions in the underlying application programs, thereby avoiding the need to completely recreate customized data models from an empty model set.

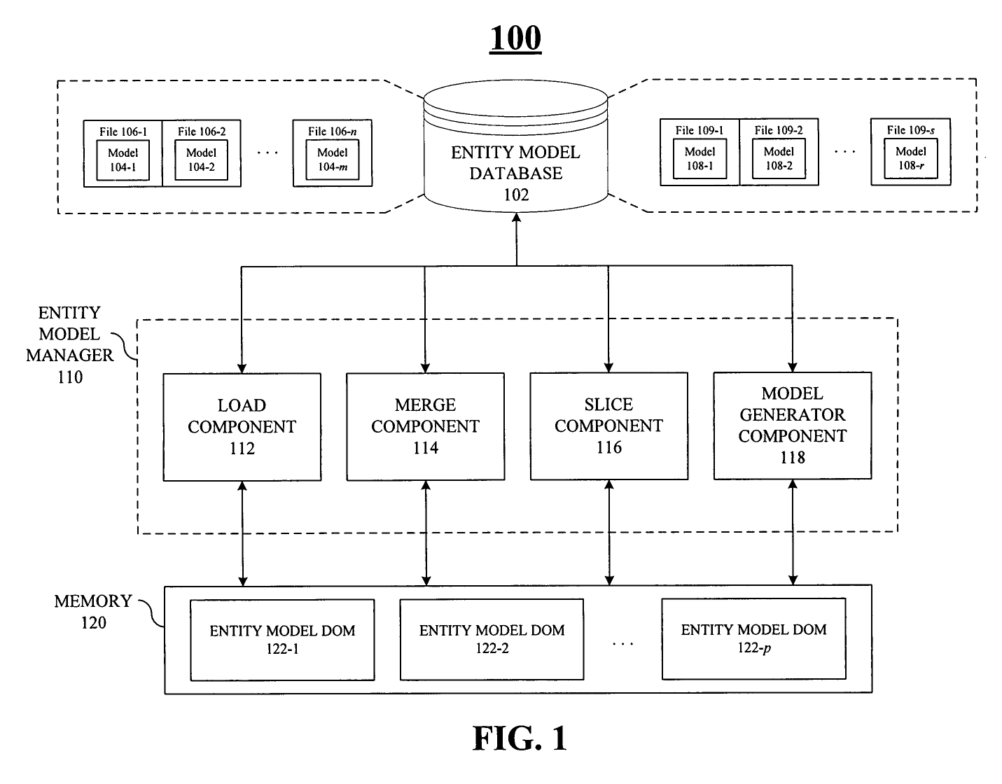

FIG. 1 illustrates one embodiment of an entity model system 100. The entity model system 100 may illustrate an entity model database 102 communicatively coupled to an entity model manager 110. The entity model manager 110 may include a load component 112, a merge component 114, a slice component 116, and a save component 118. The entity model manager 110 may be communicatively coupled to a memory unit 120. It may be appreciated that entity model system 100 may include more or less elements arranged in various topologies as desired for a given implementation. For example, the entity model system 100 may further comprise a LOB system with one or more LOB application programs, a middle tier system for the LOB system, and one or more client devices having other application programs interacting with the LOB system or LOB information provided by the LOB application programs. The embodiments are not limited in this context.

As used herein the terms “component” and “system” are intended to refer to a computer-related entity, either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In various embodiments, the entity model database 102 may comprise a data store to store various input models 104-1-m. The input models 104-1-m may be stored as corresponding structured document files 106-1-n. Examples of structured document files 106-1-n may include XML document files, HTML document files, XHTML document files, SGML document files, and any other markup language document file. A model may represent, for example, a collection of artifacts stored in a single structured file. An artifact may represent a type class that in turn is a construct of a type system. A type system defines how a programming language classifies values and expressions into types, how it can manipulate those types and how they interact. A type indicates a set of values that have the same sort of generic meaning or intended purpose. Various type systems may be suitable for use in defining the input models 104-1-m.

In various embodiments, the input models 104-1-m may include artifacts specifically for an entity. The concept of an entity is used to describe some real things of interest, such as customers, orders, and so forth. In a model the entity is defined as an abstract construct, in a sense that it is not directly observable by the client except for its identity. The identity is used to construct a reference to an entity. The client can only obtain and manipulate the entity via views. The entity defines a set of properties, where exactly one must be designated as an identity. The properties are defined on the entity in order to define shared naming, type and semantics across all views. Property values cannot be retrieved from the entity directly, and therefore they are irrelevant outside views.

In various embodiments, the entity model manager 110 may have multiple software components arranged to create, construct or generate entity model DOM 122-1-p in the memory unit 120 from information received from the one or more of the input models 104-1-m. Each entity model DOM 122-1-p comprises an in-memory representation of an input model 104-1-m. For example, each entity model DOM 122-1-p may comprise or represent a hierarchical tree of node objects, with each node object corresponding to a portion of model information, data element or artifact from the input model 104-1-m.

Once an input model 104-1-m has been loaded into the memory unit 120 as an entity model DOM 122-1-p, the entity model manager 110 may create one or more output models 108-1-r from the input model 104-1-m. The input models 104-1-m may share common data elements with the output models 108-1-r. In some embodiments, the output models 108-1-r may include some or all of the artifacts from one or more of the input models 104-1-m. In one embodiment, for example, the output models 108-1-r may include a complete set of artifacts related to a specific entity, such as a customer, a company, a product, or any other defined entity. The entity model manager 110 may store the output models 108-1-r as corresponding structured document files 109-1-s. As with the structured document files 106-1-n, examples of structured document files 109-1-s may include XML document files, HTML document files, XHTML document files, SGML document files, and any other markup language document file.

As previously described, a DOM is an object oriented programming API to process structured documents, including markup language documents such as HTML and XML documents. A DOM defines the logical structure of documents and the way a document is accessed and manipulated. As defined herein the term “document” is used in a broad sense to include any defined set of data, typically stored in a single electronic file. Increasingly, structured languages such as XML are being used as a way of representing many different kinds of information that may be stored in diverse systems, and much of this would traditionally be seen as data rather than as documents. Nevertheless, XML presents this data as documents, and the DOM may be used to manage this data. With a DOM, programmers can build documents, navigate their structure, and add, modify, or delete elements and content. Anything found in an HTML or XML document can be accessed, changed, deleted, or added using the DOM.

In various embodiments, an innovative entity model DOM may share some characteristics with the WC3 DOM for XML and HTML. The innovative entity model DOM precisely defines a set of artifacts of various types, classes or type classes, properties and method arguments for the models 104-1-m. Further, the innovative entity model DOM comprises a closed type system. A closed type system is a type system where all types used are defined by the model DOM. Since the models 104-1-m may be relied upon for various use scenarios, including defining contracts between EWS and LOB clients, there is a need to precisely define all the types in the innovative entity model DOM to ensure the contracts do not become unenforceable. In addition to precisely defining the types, properties and method arguments in the models 104-1-m, the innovative entity model DOM may provide mappings to other type systems, including a Common Language Runtime (CLR) version of the Common Type System (CTS) type system and the WC3 XML Schema (XSD) type system, and other type systems as well.

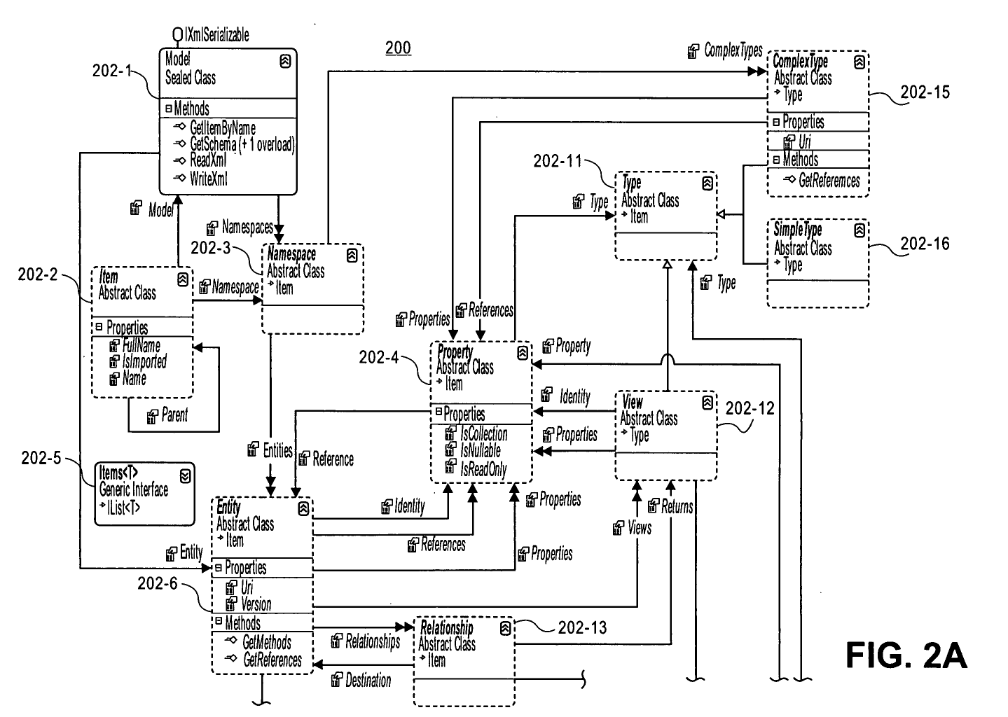

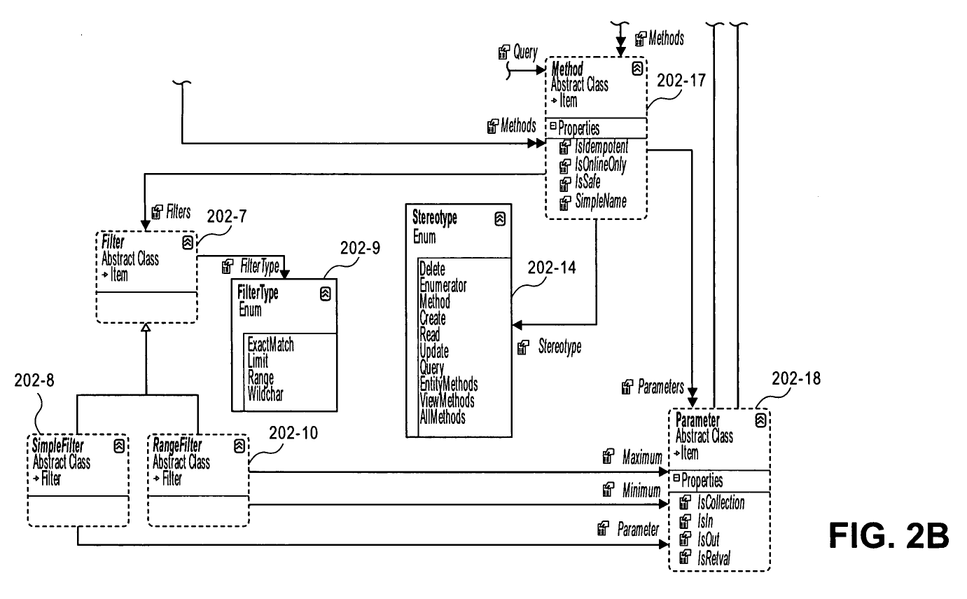

FIGS. 2A, 2B illustrate one embodiment of a class diagram 200. The class diagram 200 may provide a pictorial illustration of various public interfaces for exemplary classes 202-1-r typically used for a representative model. The public interfaces are a facade, optimized for read-only access to model information from the input models 104-1-m. The public interfaces also expose methods for serialization of an input model 104-1-m in a structured format, such as an XML format. Behind the public facade is the internal representation that matches the real serialization format of the input model 104-1-m and allows full manipulation of the model information provided by the input model 104-1-m.

Several advantages may be achieved by separating the public facade and the internal representation. For example, the serialization format does not always directly map to model artifacts. A property definition in a view and a property definition in an entity typically may use different serialization formats. In another example, there are various validation rules that must be enforced and therefore any manipulation with the input model 104-1-m should be intercepted. In yet another example, there are several sets of validation rules to be enforced and a strategy pattern should be used (e.g., complete model, incomplete model, model slice, intermediate operations during serialization, and so forth).

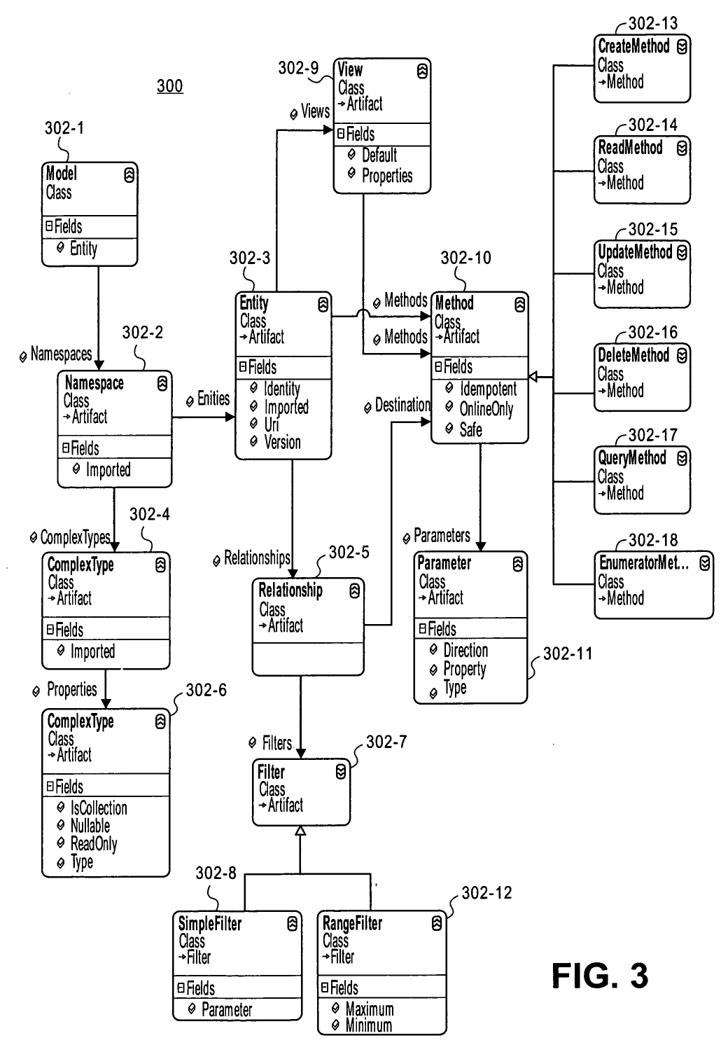

FIG. 3 illustrates one embodiment of a class diagram 300. The class diagram 300 may provide a pictorial illustration of the relationships of the XML serialization classes 302-1-s used directly to serialize an input model 104-1-m into an XML representation. It is worthy to note the differences between the public facade illustrated by the class diagram 200 and the classes illustrated by the class diagram 300.

In various embodiments, the class diagrams 200, 300 include respective Entity classes 202-6, 302-3. The Entity class represents a given entity in a model. It is also used as a reference to an entity. The Entity class is derived from an Item class and is not publicly creatable. All public properties are read-only. The Entity class may include various defined properties and methods. For example, the Entity class may include an Identity property that defines the identity of the entity. Null is a valid value for incomplete models or for imported entities; otherwise it is a member of the Properties collection of the same Entity instance. In another example, the Entity class may include a Methods property. The Methods property is a strongly typed collection of Method instances. The value is never null, although the collection might be empty. In a valid model only Delete, Query, Enumerator and Method are valid stereotypes of the members of this collection. In yet another example, the Entity class may include a Properties property. The Properties property is a strongly typed collection of Property instances. The value is never null, although the collection might be empty. For an entity definition in a valid model it contains at least the identity of the entity, although it might be empty if the entity was imported. In still another example, the Entity class may include a References property. The References property is a shortcut to a call to GetReferences(false) method. In yet another example, the Entity class may include a Relationships property. The property is a strongly typed collection of Relationship instances. The value is never null, although the collection might be empty. In still another example, the Entity class may include an Uri property that contains the URI associated with the entity. In a valid model the value is always a valid URI, where it is a unique value properly formatted per rules of URI normalization and not null or empty. In yet another example, the Entity class may include a Version property that contains a version of the entity. For valid models it is always correctly filled out, where it is not null or empty and incremented whenever a new version of the entity is released. In still another example, the Entity class may include a Views property that is a strongly typed collection of View instances. The value is never null, and the collection might be empty. For valid models the collection must contain at least single view and exactly one view must be marked as default view. In yet another example, the Entity class may include an IsImported property that is true if the complex type is imported into the model and therefore it might be incomplete. In still another example, the Entity class may include a GetMethods method that takes a stereotype as an argument and returns all the methods defined by the entity or any of its views that have the given stereotype. The stereotype enumeration is a bit flag, so it is possible to specify more then one stereotype to be returned. In yet another example, the Entity class may include a GetReferences method that takes a Boolean argument indicating whether a deep traversal is required and returns a strongly typed collection of all Property instances that are valid references to other entities. When the argument is false, only direct references are returned; otherwise the value is computed by a deep traversal through all properties of the entity and the nested complex types. For recursive structures only the first occurrence of a property is returned. In a final example, the Entity class may include a ToEntityDefinition method that converts the Entity instance to an instance of the equivalent EntityDefinition class. Since this method returns an EntityDefinition class which is for internal use only, the method is typically limited to internal use.

Referring again to FIG. 1, the entity model manager 110 may provide a set of software components to perform various defined model management operations on the object models 122-1-p. In general operation, the entity model manager 110 converts one or more of the input models 104-1-m into a corresponding entity model DOM 122-1-p in the memory unit 120. The entity model manager 110 then generates one or more output models 108-1-r comprising artifacts from the one or more input models 104-1-m. In one embodiment, for example, the artifacts may be related to a specific entity defined by an input model 104-1-m.

In one embodiment, for example, a load component 112 may be arranged to load one or more input models 104-1-m into the memory unit 120. The load component 112 may read the input models 104-1-m from the structured document files 106-1-n, and convert the data for the input models 104-1-m into serialized XML streams. The load component 112 may convert the serialized XML streams into various node objects to create the one or more entity model DOM 122-1-p.

In one embodiment, for example, a merge component 114 may be arranged to merge artifacts from multiple input models 104-1-m to create an output model 108-1-r. The merge component 114 may implement a merge algorithm defining a set of merge operations to merge model information from multiple input models 104-1-m to form a unified output model 108-1-r. The purpose of the merge component 114 is to combine multiple models together into a new model. The merge component 114 typically does not modify the original input models during merge operations, except when it is used to deserialize an XML document into an empty model.

The merge component 114 may accept a collection of XML readers and a collection of models 104-1-m. Additional overloads are simplifying the signature for edge cases when one of the arguments is not used. An example of a public interface for the merge component 114 may be shown as follows:

```
public static Model Merge(IEnumerable<XmlReader> readers,
IEnumerable<Model> models);
public static Model Merge(IEnumerable<Model> models)
{
    return Merge(models, null);
}
public static Model Merge(IEnumerable<XmlReader> readers)
{
    return Merge(null, readers);
}
internal static void Merge(Model model, XmlReader reader);
```

The merge algorithm implemented by the merge component 114 may need to address several boundary conditions. The first boundary condition is that models 104-1-m are graphs and therefore could contain cycles. The merge algorithm should be constructed to prevent infinite loops while enumerating (traversing) the input models 104-1-m. The merge algorithm may be arranged to reduce or avoid this problem by marking artifacts as they are enumerated. Alternatively, the merge algorithm may maintain a collection of processed items to accomplish the same result. A second boundary condition is that the traversal could reach a reference to an artifact before its full definition. This requires creating a reference in the output model 108-1-r to an artifact that was not yet defined. The merge algorithm may temporarily add an empty declaration to the output model 108-1-r and later merge it with the real definition. A third boundary condition is that it should be possible to merge several incomplete definitions of the same artifact. The merge algorithm should fully validate the model and detect all error cases to accomplish this task.

The merge algorithm performs merging operations in two stages. In a first stage, the merge algorithm performs enumeration over all model artifacts across all input models 104-1-m. Even though the merge algorithm describes building a unified collection, in some cases only the unified enumerator is needed. Pseudocode for the first stage of the merge algorithm may be illustrated in the following three operations as follows:
1. Each XmlReader is used to deserialize the input model into an internal representation. The public façade is not built and the references are not resolved at this stage.
2. The internal representations of all the input models are added to a single collection of all the namespaces. Duplicates are allowed since more then one model might contain the same namespace.
3. Create a new model instance (the output model).

In the second stage, the merge algorithm examines each model artifact from the unified collection and recreates each model artifact in the output model. During the second stage, the merge algorithm is performing validation operations and the public facade of the output model is being built in increments. Pseudocode for the second stage of the merge algorithm may be illustrated in six operations as follows
4. For each artifact in the unified collection that was not processed yet find the corresponding artifact with the same name in the final model. If there is one, verify that it can be merged by determining whether it is the same type of artifacts and its properties are compatible.
5. If none was found create a new artifact in the final model. The newly created artifact is incomplete but it must be immediately added to the output model to prevent infinite recursion when the model contains cycles. This can cause (recursively) creation of all parents, but only incomplete definitions should be created for them with no details.
6. Mark the input artifact as processed, to stop infinite recursion if the model contains cycles. There is no need to process the same input artifact multiple times even if it is being referenced multiple times.

7. Recursively (deep traversal) process all nested artifacts, merging them into the output model artifact. The check in step 3 should guarantee that the changes could be merged. Any references are also processed at this step in order to build the public facade.
8. Upgrade the version of the final artifact and mark it as full definition if applicable. A full definition of a previous version could be upgraded to a partial definition of a newer version. A partial definition can be upgraded to a full definition of the same or newer version. It does not matter which side was which side.
9. Once all of the artifacts from all of the namespaces are processed return the output model. Optionally, a full validation can be performed to detect breaking changes in the model.

In one embodiment, for example, a slice component 116 may be arranged to slice an artifact for an entity from an input model 104-1-m to create an output model 108-1-r. The slice component 116 may implement a slice algorithm. The function of the slice algorithm is to extract a single artifact definition from the input model 104-1-m into a new output model 108-1-r, including incomplete definitions of other artifacts that are required to fully define the selected one. The slice algorithm extracts the single artifact definition to include the transitive closure of all complex types and other references. The slice algorithm may be used to extract a subset of the input model 104-1-m for proxy generation. The slice algorithm may also be used to extract a slice of the input model 104-1-m defining a single entity that should be compiled into an EWS contract.

The slice algorithm supports two strongly typed overloads available, one for each supported artifact type, as follows:
public static Model Extract(Model model, Entity entity);
public static Model Extract(Model model, View view);

The slice algorithm as implemented by the slice component 116 is a variation of the merge algorithm as implemented by the merge component 114, with some modifications as described in the following pseudocode:
1. Instead of enumeration through unified collection of namespaces as with the merge algorithm, the slice algorithm starts with the selected artifact. This causes the parent namespace to be copied first according to recursive rule described in operation five of the merge algorithm.
2. Complex type: The full definition is copied, including all referenced complex types and all references to entities in accordance with the rule for references.
3. Entity: If it is the selected artifact, the full definition is copied including all nested artifacts. If it is the parent of the selected view, only the properties referenced by that view (including the identity) are copied. In that case only the selected view is being copied, but all methods and relationships defined directly by the entity are still being copied. In any other case only the identity property is copied.
4. View: If it is the selected artifact or if it is nested in the selected entity, the full definition is copied including all nested artifacts. In any other case it is treated as a complex type, where only its properties are copied. The parent entity is also copied.
5. Reference: The target entity is also copied, but typically only its identity.
6. Relationship: The target view and its query method are also copied.
7. Any other artifacts are only copied if they are nested by the selected entity or view. When the selected artifact is a view, however, the resulting model is not marked as a model slice and it cannot be compiled into an assembly defining an EWS contract.

In one embodiment, for example, a save component 118 may be arranged to store an output model 108-1-r as a structured document file 109-1-s. In one embodiment, for example, the save component 118 may store the output model 108-1-r as an XML document file 109-1-s.

Operations for the entity model system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the entity model system 100 or alternative elements as desired for a given set of design and performance constraints.

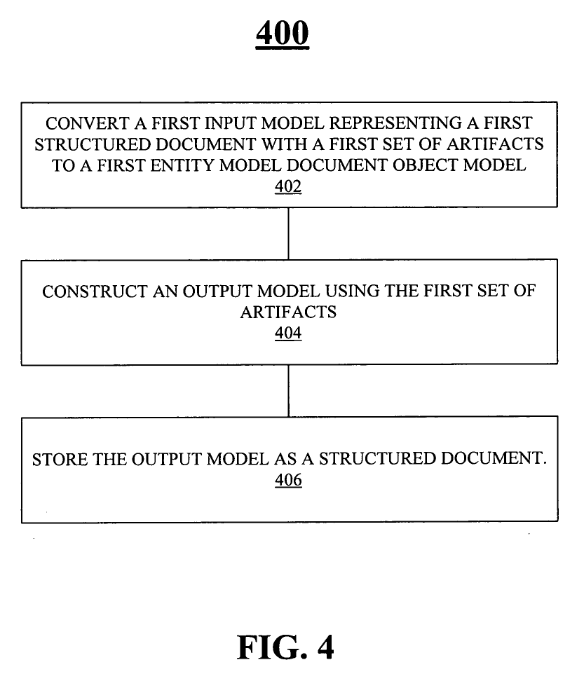

FIG. 4 illustrates a logic flow 400. The logic flow 400 may be representative of the operations executed by one or more embodiments described herein. As shown in FIG. 4, the logic flow 400 may convert a first input model representing a first structured document with a first set of artifacts to a first entity model DOM at block 402. The logic flow 400 may construct an output model using the first set of artifacts at block 404. The logic flow 400 may store the output model as a structured document at block 406. The embodiments are not limited in this context.

In one embodiment, for example, the output model may be constructed with artifacts from multiple input models 104-1-m. The merge component 114 may convert a first input model 104-1 representing a first structured document 106-1 with a first set of artifacts to a first entity model DOM 122-1. The merge component 114 may convert a second input model 104-2 representing a second structured document 106-2 with a second set of artifacts to a second entity model DOM 122-2. The merge component 114 may merge the first set of artifacts with the second set of artifacts to construct an output model 108-1. The save component 118 may store the output model 108-1 as a structured document 109-1.

In one embodiment, for example, the merge component 114 may merge the first set of artifacts and the second set of artifacts by enumerating both sets of artifacts. The merge component 114 may create the output model with output artifacts corresponding to each enumerated artifact. The merge component 114 may copy the enumerated artifacts into the corresponding output artifacts to create the output model 108-1.

In one embodiment, for example, the output model may be constructed with artifacts from a single input model 104-1. The slice component 116 may slice an entity artifact from the first set of artifacts to construct the output model 108-1. To accomplish this, the slice component 116 may select an entity artifact from the first set of artifacts. The slice component 116 may enumerate the selected entity artifact and any referenced artifacts. The slice component 116 may create the output model 108-1 with output artifacts corresponding to each enumerated artifact. The slice component 116 may copy the enumerated artifacts into the corresponding output artifacts to create the output model 108-1.

In one embodiment, for example, the load component 112 may convert the first input model 104-1 representing the first structured document 106-1 with a first set of artifacts to a first entity model DOM 122-1 by reading the first set of artifacts from a serialized input stream to create the first entity model DOM 122-1. The serialized input stream may comprise an XML representation for the first input model 104-1. The load component 112 may receive the serialized XML input stream, and deserialize the XML input stream to create the first entity model DOM 122-1. Similarly, the save component 118 may write the first set of artifacts to a serialized output stream to create the output model 108-1 and store it as an XML document file 109-1.

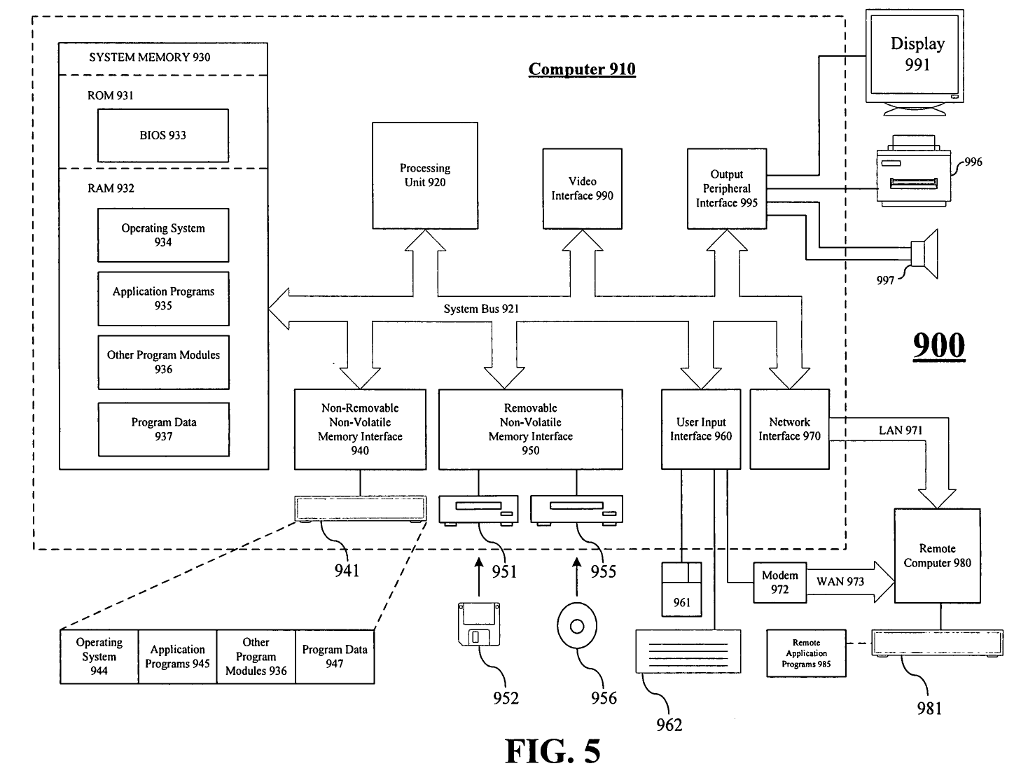

FIG. 5 illustrates a block diagram of a computing system architecture 900 suitable for implementing various embodiments, including the managed taxonomy entity model system 100. It may be appreciated that the computing system architecture 900 is only one example of a suitable computing environment and is not intended to suggest any limitation as to the scope of use or functionality of the embodiments. Neither should the computing system architecture 900 be interpreted as having any dependency or requirement relating to any one or combination of components illustrated in the exemplary computing system architecture 900.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 5, the computing system architecture 900 includes a general purpose computing device such as a computer 910. The computer 910 may include various components typically found in a computer or processing system. Some illustrative components of computer 910 may include, but are not limited to, a processing unit 920 and a memory unit 930.

In one embodiment, for example, the computer 910 may include one or more processing units 920. A processing unit 920 may comprise any hardware element or software element arranged to process information or data. Some examples of the processing unit 920 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 920 may be implemented as a general purpose processor. Alternatively, the processing unit 920 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 910 may include one or more memory units 930 coupled to the processing unit 920. A memory unit 930 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 910. The embodiments are not limited in this context.

In one embodiment, for example, the computer 910 may include a system bus 921 that couples various system components including the memory unit 930 to the processing unit 920. A system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 910 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 900. Examples of computer readable media for computing system architecture 900 may include, but are not limited to, volatile and/or nonvolatile memory such as ROM 931 and RAM 932. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 930 includes computer storage media in the form of volatile and/or nonvolatile memory such as ROM 931 and RAM 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 5 illustrates operating system 934, application programs 935, other program modules 936, and program data 937.

The computer 910 may also include other removable/non-removable, volatile/nonvolatile computer storage media. By way of example only, FIG. 5 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 5, provide storage of computer readable instructions, data structures, program modules and other data for the computer 910. In FIG. 5, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor 991, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer (PC), a server, a router, a network PC, a peer device or other common network node, and typically includes many or all of the elements described above relative to the computer 910, although only a memory storage device 981 has been illustrated in FIG. 5 for clarity. The logical connections depicted in FIG. 5 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other technique suitable for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 5 illustrates remote application programs 985 as residing on memory device 981. It will be appreciated that the network connections shown are exemplary and other techniques for establishing a communications link between the computers may be used. Further, the network connections may be implemented as wired or wireless connections. In the latter case, the computing system architecture 900 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the managed taxonomy entity model system 100 and/or computing system architecture 900 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously provided for the memory unit 130. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
converting a first input model representing a first structured document with a first set of artifacts to a first entity model document object model; and
constructing an output model using said first set of artifacts.

2. The method of claim 1, comprising:
converting a second input model representing a second structured document with a second set of artifacts to a second entity model document object model; and
merging said first set of artifacts with said second set of artifacts to construct said output model.

3. The method of claim 1, comprising:
converting a second input model representing a second structured document with a second set of artifacts to a second entity model document object model;
enumerating said first set of artifacts and said second set of artifacts;
creating said output model with output artifacts corresponding to each enumerated artifact; and
copying said enumerated artifacts into said corresponding output artifacts to create said output model.

4. The method of claim 1, comprising slicing an entity artifact from said first set of artifacts to construct said output model.

5. The method of claim 1, comprising selecting an artifact from said first set of artifacts;
enumerating said selected artifact and any referenced artifacts;
creating said output model with output artifacts corresponding to each enumerated artifact; and
copying said enumerated artifacts into said corresponding output artifacts to create said output model.

6. The method of claim 1, comprising storing said output model as a structured document.

7. The method of claim 1, comprising reading said first set of artifacts from a serialized input stream to create said first entity model document object model.

8. The method of claim 1, comprising writing said first set of artifacts to a serialized output stream to create said output model.

9. An article comprising a storage medium containing instructions that if executed enable a system to:
convert a first input model representing a first markup language document with a first set of artifacts to a first entity model document object model representing a first tree of node objects; and
construct an output model using said first set of artifacts or a subset of said set of artifacts.

10. The article of claim 9, further comprising instructions that if executed enable the system to:
convert a second input model representing a second markup language document with a second set of artifacts to a second entity model document object model representing a second tree of node objects; and
merge said first set of artifacts with said second set of artifacts to construct said output model.

11. The article of claim 9, further comprising instructions that if executed enable the system to slice a single artifact from said first set of artifacts to construct said output model.

12. The article of claim 9, further comprising instructions that if executed enable the system to slice an entity artifact from said first set of artifacts to construct said output model.

13. The article of claim 9, further comprising instructions that if executed enable the system to store said output model as a markup language document.

14. The article of claim 9, further comprising instructions that if executed enable the system to read said first set of artifacts from a serialized input stream to create said first entity model document object model.

15. An apparatus comprising an entity model manager to load at least one input model representing a markup language document into a memory unit, generate an entity model document object model comprising artifacts from said input model, and generate an output model using said artifacts.

16. The apparatus of claim 15, comprising a load component to load said input model into said memory unit.

17. The apparatus of claim 15, comprising a merge component to merge artifacts from multiple input models to create said output model.

18. The apparatus of claim 15, comprising a slice component to slice an artifact for an entity from said input model to create said output model.

19. The apparatus of claim 15, comprising a save component to store said output model as an extensible markup language document file.

20. The apparatus of claim 15, said markup language document comprising an extensible markup language document.
